(19) United States
(12) Patent Application Publication
(10) Pub. No.: US 2004/0047496 A1
(43) Pub. Date: Mar. 11, 2004

(54) Communication of medical information

(76) Inventors: Ralph Philip Highnam, Oxford (GB); John Michael Brady, Oxford (GB); Christian Peter Behrenbruch, Oxford (GB)

Correspondence Address: BOZICEVIC, FIELD & FRANCIS LLP, 200 MIDDLEFIELD RD, SUITE 200, MENLO PARK, CA, 94025, US

(21) Appl. No.: 10/236,223

(22) Filed: Sep. 5, 2002

(51) Int. Cl. G06K 9/00

(52) U.S. Cl. 382/128

(57) ABSTRACT

A method of communicating medical information comprising the steps of: obtaining raw image data from at least a portion of the body of a subject; constructing a computer representation of the raw image data; applying image processing to the computer representation; and giving the result of the image processing to a person to whom medical information contained in the image data is to be communicated.

### BACKGROUND OF THE INVENTION

1. Field of the Invention

The present invention relates to a method and apparatus for the communication, for example to a non-specialist, of medical information derived from medical images of a subject.

2. Description of the Related Art

Previously, clinicians used the actual raw images to explain to a person and their fellow clinicians about what is happening to someone's body part. For example, in the case of mammography, clinicians such as oncologists, radiologists or surgeons used the actual film mammogram to explain to a woman about what is happening with her breasts, for example “Mrs Smith you have a cancer just there”, or “Mrs Jones you have a cyst as you can see just here”. This process is problematic because the mammogram is a complex technical image that the woman can find hard to understand and very difficult to use to explain to her partner or husband and to her friends. Further problems are that time pressures on medical professionals mean that they do not always have as much time as would be desirable to devote to explaining the images to their clients. This is exacerbated by the fact that after a consultation, research has shown that patients typically remember as little as 25% of what they have been told by a Doctor.

Another concern is that of the secure storage of medical images. For example, one piece of research found that 22% of mammograms are lost between screenings and 50% are found only with a high degree of difficulty. This is especially important for healthy women whose future clinicians need previous mammograms to perform accurate diagnosis.

### SUMMARY OF THE INVENTION

It is therefore an object of the invention to provide a technique for the communication of medical information which improves on the prior art techniques.

The present invention provides a method of communicating medical information comprising the steps of: obtaining raw image data from at least a portion of the body of a subject; constructing a computer representation of the raw image data; applying image processing to the computer representation; and presenting the result of the image processing to a person to whom medical information contained in the image data is to be communicated.

Vision is the human's most powerful sense. We readily understand information in the form of images and motion sequences. It follows that results of the image processing can assist in the communication of medical information, for example, when said person is a non-specialist in the particular medical field of the body portion of the image, or when said person is a non-specialist in the particular imaging technique used to obtain the raw image data, which would otherwise make interpretation of the image data difficult. The person may to whom information is to be communicated may, in fact, also be the subject of the imaging.

Optionally, the step of applying image processing comprises producing a 3D representation of the portion of the body of the subject. This often makes it easier for non-specialists to visualise.

Optionally, the step of applying image processing comprises producing a movie sequence of images over time. This often makes it easier to identify subtle changes.

Optionally, the step of applying image processing comprises generating a representation of the portion of the body of the subject in a form more easily intelligible using visual perception abilities.

The method of the invention may advantageously further comprise the step of a clinician explaining to said person the medical information to be conveyed with the aid of the result of the image processing.

Optionally, said presenting step further comprises recording the result of the image processing on a computer-readable medium, for example a CD, which is given to said person. Alternatively, said presenting step further comprises enabling said person to access the result of the image processing via a network.

Preferably, said presenting step further comprises giving the computer representation of the image data as well as the result of the image processing. This means that it is less likely that the image data will be lost. Also, if new image processing techniques are later developed, they can be applied to the original image data. The method of the invention can also, optionally, encompass conveying to said person said computer representation of the image data and software to perform said step of applying image processing.

Optionally, said presenting step further comprises giving to said person information customized to a medical condition of said subject illustrated by the result of the step of applying image processing. This enables customized information to be given that is tailored to the actual subject of the imaging, and is relevant to their condition.

Suitable raw image data for use with the invention includes, for example, an ultrasound or magnetic resonance or x-ray or standard camera image. Optionally, the image is a remote sensing or non-invasive image.

Optionally, said portion of the body of the subject is one selected from the group consisting of: breast, heart, stomach, lung and brain. According to one particular preferred embodiment of the invention, said raw image data comprises at least one mammogram.

The invention may be embodied in a system adapted to perform the relevant steps of the method above, and it may be embodied by a computer program comprising program code means for executing the method. Thus, the invention further provides for a computer program storage medium carrying such a computer program, and also a computer system programmed to carry out the method.

### BRIEF DESCRIPTION OF THE DRAWINGS

FIG. 1 shows a cranio-caudal view of a breast (X-Ray mammogram);

FIG. 2 shows a medio-lateral oblique view of a breast (XRay mammogram);

FIG. 3 shows a 3D representation of a woman's breast, obtained by image processing of mammograms viewed from 2 different angles; and

FIG. 4 shows 2 mammograms in which a cancer has developed over time (left, first epoch, right, second epoch).

### DETAILED DESCRIPTION OF THE PREFERRED EMBODIMENTS

The present invention will next be described in more detail by way of example. However the present invention should not be construed as being limited thereto.

The currently preferred mode of putting the invention into effect will be described in the context of mammography.

Several mammograms are taken and a computer representation of those mammograms constructed either via a digitizer or via sketching of via other suitable methods (such as directly digital methods).

Image processing is applied to the computer representations to build them into a form that a non-radiologist, such as the woman herself or her surgeon, can understand. The image processing is for helping communication of medical information.

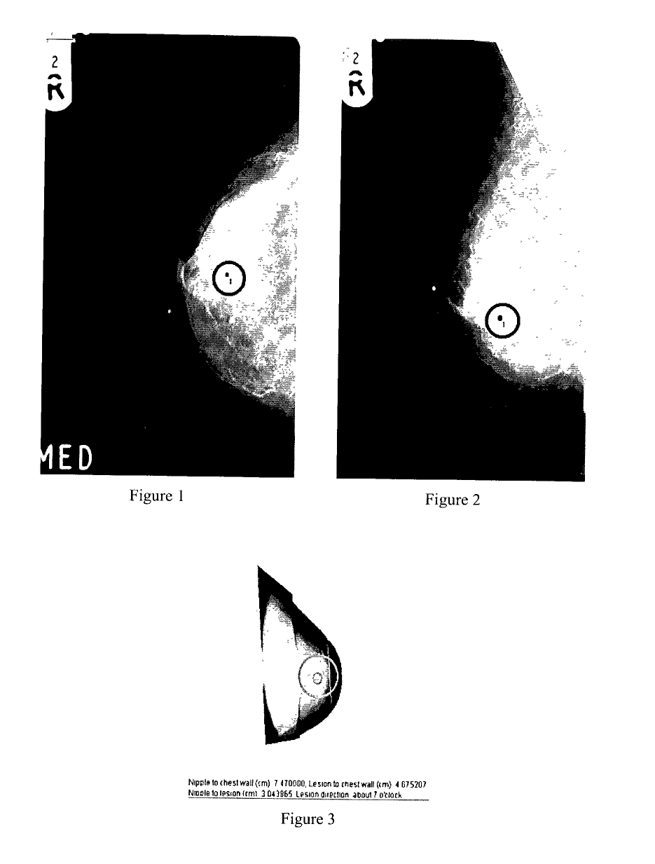

One example of such image processing is to generate a 3D representation of the breast that allows the non-specialist to picture easily where an object is in her breast. FIG. 3 is an example of such a 3D representation. Information for producing such images is disclosed in Patent Publication WO 01/69533. These 3D reconstructions can be obtained from merely two mammograms of the breast having different views, such as the X-Ray mammograms of FIGS. 1 and 2 which show a cranio-caudal view of a breast and a medio-lateral oblique view of a breast, respectively. In the images shown in FIGS. 1, 2 and 3, a feature has been highlighted. The 3D reconstruction can be rotated in real time using computer software to give a definite and easy to perceive intuitive understanding of where the feature, such as a lump, is located in the breast of the woman concerned and how it might look in 3D (smooth, circular, spiculated etc). The resulting image according to any embodiment of the invention, for example a 3D representation, may convey not only the location of the feature but also its shape. This facilitates easy explanation by the clinician to the woman of the condition (if any) and also enables the woman more easily to perform self-examination or palpation. The results of the image processing can also be used to help communication between clinicians, for example a radiologist can convey to a surgeon where to intervene in the breast.

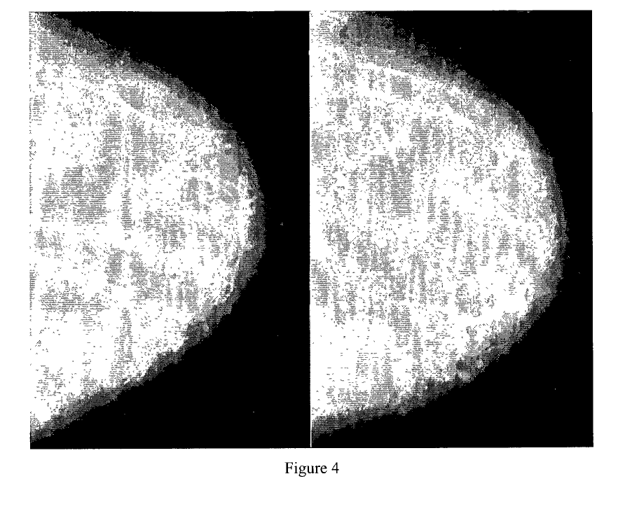

Another example of image processing to be applied, which also has the advantages outlined above, is building a sequence of 2 or more images into a movie loop to enable changes in the condition of the breast to be readily identified over time. FIG. 4 shows 2 mammograms in which a cancer has developed over time.

Consider as a first example that there are two images of nominally the same body part but taken at different times. Once the images have been (non-rigidly) registered, so that corresponding points of the body part appear at the same location in the two images, the image difference may be shown by subtracting a suitable version of one of the images from the other. The Phi phenomenon, well known in human visual perception, may be used to good effect to make any changes explicit: the two images are shown in rapid alternation, as a movie loop. The human visual system quickly detects changes even when they would be difficult to see in a subtraction image. Of course, the Phi phenomenon is not restricted to two images in sequence—if there is a sequence of images I₁, I₂, . . . Iₙ, they too can be played as a cine loop to indicate progressive changes. The human visual system quickly detects progressive changes.

The raw images do not have to be obtained contemporaneously, but could be spaced apart by days, weeks, months or more. To enhance this technique, processing can be applied to achieve registration between such images to correct for e.g. movement of the body between images or non-rigid body deformations. More is disclosed in Highnam & Brady, “Mammographic Image Analysis”, Kluwer Academic Publishers (ISBN 0-7923-5620-9) where the technique is discussed for diagnosis, not as an aid to communication.

Features can be identified in individual images and then tracked through a sequence of image frames. In this way, the information within the images becomes easy for a non-radiologist to understand. It is generally much easier to identify changes over time when images are viewed successively in a sequence, such as a movie, rather than viewing the images side-by-side.

The clinician can lead the woman through a step-by-step explanation of her medical condition, whether healthy or not, with the assistance of the visualization provided by the result of the image processing. The presentation of the result of the image processing may take the form of viewing a screen display, such as on a computer monitor, or a hard-copy print-out, such as on paper or film, but is not limited to any particular form of display process. The presentation of the result of the image processing can also take the form of handing over a physical medium on which the data are recorded as explained below. The results of the image processing can also be recorded onto a CD or other computer readable medium (such as a magnetic disk, floppy disk, hard disk, magneto-optical disk, magnetic card, IC card, magnetic tape and so on), or even printed out, along with some or all the relevant personalized explanation, plus much more verified information about, for example, breast disease. The unprocessed mammogram data can also be recorded onto the CD for security so that the woman can keep her own copy. Computer software may also be provided on the CD to enable the image processing to be performed on the mammograms, instead of recording the actual results of the image processing.

The woman can take away the CD (or other media) and review the information specific to herself in her own time at home, and explain and discuss it with her partner or friends or primary physician or other professionals. The CD can include information and a practical guide to self-examination using the woman's own breast as the example.

A further option is for the patient to be given access to her data over a network with appropriate security and confidentiality measures, rather than being given a CD or other media.

What is claimed is:

1. A method of communicating medical information comprising the steps of:
obtaining raw image data from at least a portion of the body of a subject;
constructing a computer representation of the raw image data;
applying image processing to the computer representation; and
presenting the result of the image processing to a person to whom medical information contained in the image data is to be communicated.

2. A method according to claim 1, wherein said person is a non-specialist in the particular medical field of the body portion of the image.

3. A method according to claim 1, wherein said person is a non-specialist in the particular imaging technique used to obtain the raw image data.

4. A method according to claim 1, wherein said person is also said subject.

5. A method according to claim 1, wherein the step of applying image processing comprises producing a 3D representation of the portion of the body of the subject.

6. A method according to claim 1, wherein the step of applying image processing comprises producing a movie sequence of images over time.

7. A method according to claim 1, wherein the step of applying image processing comprises generating a representation of the portion of the body of the subject in a form more easily intelligible using visual perception abilities.

8. A method according to claim 1, further comprising the step of a clinician explaining to said person the medical information to be conveyed with the aid of the result of the image processing.

9. A method according to claim 1, wherein said presenting step further comprises recording the result of the image processing on a computer-readable medium which is given to said person.

10. A method according to claim 9, wherein said computer readable medium is a CD.

11. A method according to claim 1, wherein said presenting step further comprises enabling said person to access the result of the image processing via a network.

12. A method according to claim 1, wherein said presenting step further comprises giving the computer representation of the image data as well as the result of the image processing.

13. A method according to claim 1, further comprising conveying to said person said computer representation of the image data and software to perform said step of applying image processing.

14. A method according to claim 1, wherein said presenting step further comprises giving to said person information customized to a medical condition of said subject illustrated by the result of the step of applying image processing.

15. A method according to claim 1, wherein the raw image data is an ultrasound or magnetic resonance or x-ray or standard camera image.

16. A method according to claim 1, wherein the image is a remote sensing or non-invasive image.

17. A method according to claim 1, wherein said portion of the body of the subject is one selected from the group consisting of: breast, heart, stomach, lung and brain.

18. A method according to claim 1, wherein said raw image data comprises at least one mammogram.

19. A computer program comprising program code means for executing on a computer the method of any one of the preceding claims.

20. A computer program product carrying the computer program of claim 19.

21. An image processing system comprising image processing means adapted to perform the method of any one of the preceding claims.
